(19) United States
(12) Patent Application Publication
(10) Pub. No.: US 2026/0052137 A1
(43) Pub. Date: Feb. 19, 2026

(54) NETWORK EDGE PROTECTION USING LOCALITY INFORMATION

(71) Applicants: DISH Wireless L.L.C., Englewood, CO (US); DISH Network Technologies India Private Limited, Bangalore (IN)

(72) Inventors: Abhishek Jayprakash Shirke, Aurora, CO (US); MythriAmulya Sabhapati, Highlands Ranch, CO (US); Jaya Chandra Chikatmarla, Highlands Ranch, CO (US); Sruthi Nair, Aurora, CO (US); Dawood Shahdad, Aurora, CO (US); Kumar Anshuman, Bangalore (IN)

(21) Appl. No.: 18/802,165

(22) Filed: Aug. 13, 2024

(51) Int. Cl. H04L 9/40; H04L 67/51; H04W 12/63; H04W 64/00

(52) U.S. Cl. CPC H04L 63/08; H04L 67/51; H04W 12/63; H04W 64/003

(57) ABSTRACT

Implementations are described herein for network edge protection using locality information. In some implementations, a security component of a primary network may receive, from a security component of a secondary network, a first network function discovery request. The security component of the primary network may generate a second network function discovery request that is based on the first network function discovery request and that includes location information. A network repository function of the primary network may determine, based on the location information, network function priority information for a plurality of network functions of the primary network. The network repository function may provide the network function discovery response to the security component of the primary network, and the security component of the primary network may send the network function discovery response to the security component of the secondary network.

### BACKGROUND

A security edge protection proxy (SEPP) is a security component in wireless communication networks for safeguarding interconnectivity between different network operators. SEPP can be used to protect against potential security vulnerabilities that may arise during cross-network communications. For example, SEPP can be used to improve user data privacy, signaling data integrity, and authentication of network nodes during communications between the network nodes in the wireless communication network. In 5G architecture, SEPP may be implemented at the edge of the network, serving as a gateway through which most or all inter-operator traffic passes. SEPP may use a robust set of security protocols and encryption techniques to verify the identity of the originating network and to encrypt data in transit, thereby preventing unauthorized access and data tampering. This may be important for maintaining the trust framework essential to the multi-operator environment of global 5G networks, ensuring secure and seamless communication across different geographical and administrative domains.

### BRIEF DESCRIPTION OF THE DRAWINGS

The present disclosure is illustrated by way of example, and not by way of limitation, in the figures of the accompanying drawings.

FIG. 1 is a block diagram of a wireless communication system that includes a security edge protection proxy locality component for performing network edge protection using locality information, according to at least one embodiment.

FIGS. 2A-2C are diagrams of network edge protection without using locality information, according to at least one embodiment.

FIG. 3 is a flow diagram of an example method of network edge protection using locality information implemented in one or more home network components, according to at least one embodiment.

FIG. 4 is a flow diagram of an example method of network edge protection using locality information implemented in one or more visiting network components, according to at least one embodiment.

FIGS. 5A-5C are diagrams of network edge protection using locality information, according to at least one embodiment.

### DETAILED DESCRIPTION

Technologies for providing network edge protection using locality information are described. The following description sets forth numerous specific details, such as examples of specific systems, components, methods, and so forth, in order to provide a good understanding of several aspects of the present disclosure. It will be apparent to one skilled in the art, however, that at least some aspects of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

A mobile device may connect to a home network (e.g., a primary network) for performing wireless communications within a coverage area of the home network. In some cases, the mobile device may move outside of the coverage area of the home network and may connect to a visiting network (e.g., a secondary network) for performing wireless communications within a coverage area of the visiting network. This may be referred to as roaming. Roaming is a service that allows mobile devices to access network resources using a visiting network when the mobile devices are outside of a home network coverage area. When the mobile device moves into the visiting network coverage area, the mobile device may first attempt to register with the visiting network by providing identity information of the mobile device. The visiting network may contact the home network (e.g., a home location register (HLR) or equivalent system in the home network) to verify the subscriber data and confirm that roaming agreements exist between the two networks. Once verified, the visiting network may grant the mobile device access to one or more services provided by the visiting network. This process ensures that users can maintain mobile service continuity, irrespective of geographical location, without compromising the security or functionality of their service.

As described above, SEPP is a security component in wireless communication networks for safeguarding interconnectivity between different network operators. A SEPP may function as a security gateway at an edge of a mobile network operator (MNO) network, focusing on protecting and managing traffic that traverses the boundaries of different network domains, such as in roaming scenarios. The SEPP may primarily be responsible for securing the interconnect points between different operator networks. The SEPP may use encryption and integrity protection mechanisms to ensure that the data exchanged between networks is not intercepted or tampered with by unauthorized parties. Additionally, the SEPP may filter and inspect incoming and outgoing traffic to ensure compliance with agreed security policies and standards, such as by checking that the traffic conforms to the types of allowed communications and that it comes from or is sent to authenticated network entities. Further, the SEPP may manage the authentication of network entities that attempt to interact with the network, for example, to ensure that only legitimate operators or network functions can establish connections, and may manage the authorization processes to confirm that these entities are allowed to access the specific services they are requesting.

The SEPP may communicate with a network repository function (NRF) that serves as a central registry for managing services that are available within the wireless communication network. For example, the NRF may facilitate the discovery and registration of network functions, enabling the network functions to locate and communicate with each other as part of a service-based architecture. When network functions are deployed or scaled in the wireless network, the network functions may register their service information and capabilities with the NRF, including details such as endpoints, supported features, and location data. Additionally, the network functions can query the NRF to discover peers that match specific requirements. Some examples of network functions include an authentication server function (AUSF), a unified data management (UDM) function, a session management function (SMF), and a user plane function (UPF). The AUSF may manage the authentication of users within the wireless network, improving secure access to network services by the mobile device. For example, the AUSF may process authentication data of the mobile device, verify the authentication data against credentials, and provide the authentication results to other network functions. In some cases, the AUSF may interact with the UDM to retrieve the stored authentication credentials. Additionally, the AUSF may communicate with an access and mobility management function (AMF) to signal the authentication status of the mobile device. The UDM may be responsible for managing and storing subscriber-specific data, such as profiles, authentication information, and service authorizations in the wireless network. The UDM may serve as a central database for user information that is accessed by other network functions, such as the AUSF for authentication purposes and the SMF for session management details. The SMF may manage and maintain session states for user connections in the wireless network. The SMF may be responsible for session establishment, modification, and release. The SMF may interact with the UDM to retrieve subscription information that is necessary for session setup. Additionally, the SMF may interact with the UPF to configure and manage routing paths for user data. The UPF may manage the routing and forwarding of user data traffic in the wireless network. The UPF may connect to external data networks and may enforce policies related to data transport and usage.

In some examples, when the mobile device attempts to connect to the visiting network, such as when the mobile device is outside of the coverage area of the home network, a SEPP of the visiting network may communicate with a SEPP of the home network in order to enable the mobile device to securely communicate using the visiting network. During this process, the SEPP of the home network may provide the SEPP of the visiting network with a list of local network functions associated with the home network. For example, the SEPP of the home network may provide the SEPP of the visiting network with a list of AUSFs that includes authentication data for various locations of the home network. In one example, the list of AUSFs may include an eastern AUSF that is used by the home network within an eastern portion of a geographical area, a central AUSF that is used by the home network within a central portion of the geographical area, and a western AUSF that is used by the home network within a western portion of the geographical area. The visiting network may (randomly) select one of the home network AUSFs from the list of AUSFs to authenticate the mobile device in the visiting network. However, the visiting network may not be configured with information that enables the visiting network to intelligently select which AUSF is to be used. In one example, the mobile device may be roaming in the western portion of the geographical area and may connect to the visiting network for wireless communications. The visiting network may receive the list of AUSFs and may randomly select the eastern AUSF to be used for authenticating the mobile device. This may increase signaling latency, for example, due to the traffic being routed from the mobile device in the western portion of the geographical area, to the AUSF in the eastern portion of the geographical area, and, finally, back to the visiting network in the western portion of the geographical area. This may create an undesirable user experience, for example, by resulting in service delays connecting to and otherwise communicating in the visiting network.

Aspects of the present disclosure address the above and other deficiencies by providing network edge protection using locality information. In some aspects, the SEPP of the visiting network may send a first network function discovery request to the SEPP of the home network. The first network function discovery request may be used by the SEPP of the visiting network to discover one or more network functions (local network functions) on the home network that can be used to enable communications by a mobile device within a coverage area of the visiting network. For example, the visiting SEPP may receive a connection request from a mobile device that is subscribed to the home network but that is outside of a coverage area of the home network and within a coverage area of the visiting network, and may transmit the first network function discovery request to the SEPP of the home network responsive to receiving the connection request.

The SEPP of the home network may generate a second network function discovery request that is based on the first network function discovery request and that includes locality information. The locality information may indicate at least one of the location of the mobile device, the location of the SEPP of the visiting network, or the location of a network repository function of the visiting network. A network repository function of the home network may receive the second network function discovery request from the SEPP of the home network and may determine network function priority information for a plurality of network functions of the home network based on the location information. In some aspects, the plurality of network functions of the home network may include a plurality of authentication server functions, a plurality of unified data management functions, a plurality of session management functions, or a plurality of user plane functions, among other examples. The network function priority information may indicate a primary network function and at least one secondary network function. For example, the network function priority information may include a list of network functions that includes a primary (default) network function and one or more secondary (backup) network functions to be used by the visiting network for connecting with the mobile device. The network repository function of the home network may provide, to the SEPP of the home network, a network function discovery response that includes the network function priority information, and the SEPP of the home network may send the network function discovery response to the SEPP of the visiting network. Thereafter, an access and mobility management function of the visiting network may communicate with the primary network function indicated in the network function discovery response to enable the mobile device to communicate within the visiting network.

Some advantages of the present disclosure include reducing latency in wireless communications. Some advantages of the present disclosure include enabling a SEPP of a home network to provide location information to a network repository function of the home network. This may further enable the network repository function of the home network to determine a priority of network functions of the home network based on the location information. For example, this may enable the network repository of the home network to determine a primary (default) network function of the home network, and one or more secondary (backup) network functions of the home network, based on a current location of the mobile device and/or based on the coverage area of the visiting network. Some advantages of the present disclosure include enabling a visiting network to authenticate a mobile device with reduced latency by selecting an AUSF of the home network based on the location of the mobile device or the coverage area of the visiting network. Some advantages of the present disclosure include enabling a visiting network to obtain subscription information for a mobile device with reduced latency by selecting an UDM of the home network based on the location of the mobile device or the coverage area of the visiting network. Some advantages of the present disclosure include enabling a visiting network to manage communication sessions by a mobile device with reduced latency by selecting an SMF of the home network based on the location of the mobile device or the coverage area of the visiting network. Some advantages of the present disclosure include enabling a visiting network to transmit data to the mobile device and receive data from the mobile device with reduced latency by selecting a UPF of the home network based on the location of the mobile device or the coverage area of the visiting network. These example advantages, among others, are described in more detail below.

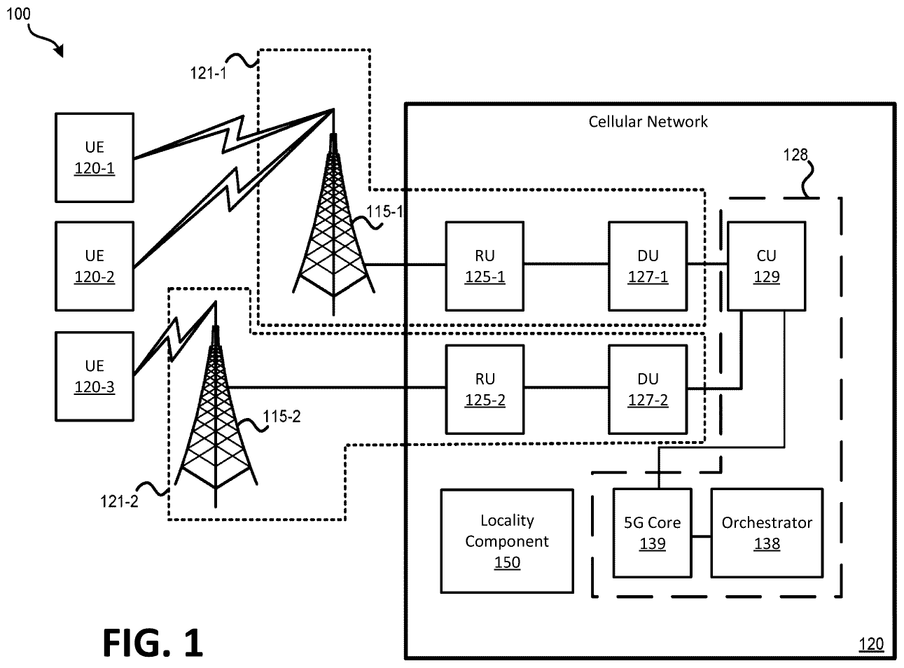

FIG. 1 is a block diagram of a wireless communication system 100 that includes a locality component 150 for performing network edge protection using locality information, according to at least one embodiment. The wireless communication system 100 may include a 5G NR cellular network. Other types of cellular networks, such as 4G, 6G, or 7G cellular networks, among other examples, may also be possible. In some aspects, wireless communication system 100 includes one or more user equipments (UEs) 120 (shown as UE 120-1, UE 120-2, and UE 120-3), a base station 115, a cellular network 120, one or more radio units (RU) 125, one or more distributed units (DU) 127, one or more centralized units (CU) 129, a 5G core 139, and an orchestrator 138. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider to accommodate a location where the functionality of such components is needed.

The UE 120 can represent various types of end-user devices, such as cellular phones, smartphones, cellular modems, cellular-enabled computerized devices, sensor devices, gaming devices, access points (APs), and computerized devices capable of communicating via the cellular network. Generally, the UE can represent any type of device that has an incorporated 5G interface, such as a 5G modem. Examples can include sensor devices, Internet of Things (IoT) devices, manufacturing robots, unmanned aerial (or land-based) vehicles, and network-connected vehicles, among other examples. Depending on the location of individual UEs, the UE 120 may use RF to communicate with various base stations of the cellular network 120. In some aspects, a first base station (base station 121-1) can include structure 115-1, RU 125-1, and DU 127-1. Structure 115-1 may be any structure to which one or more antennas (not illustrated) of the base station are mounted. For example, structure 115-1 may be a dedicated cellular tower, a building, a water tower, or any other manufactured or natural structure to which one or more antennas can reasonably be mounted to provide cellular coverage to a geographic area. A second base station (base station 121-2) can include structure 115-2, RU 125-2, and DU 127-2.

Real-world implementations of the system 100 can include many (e.g., thousands) of base stations and many CUs and 5G core 139. The base station 115 can include one or more antennas that allow the RUs 125 to communicate wirelessly with the UEs 120. The RUs 125 can represent an edge of the cellular network 120 where data is transitioned to a wireless communication. The radio access technology (RAT) used by RU 125 may be 5G NR RAT, or some other RAT. The remainder of the cellular network 120 may be based on an exclusive 5G architecture, a hybrid 4G/5G architecture, a 4G architecture, or some other cellular network architecture. The base station equipment 121 may include an RU (e.g., RU 125-1) and/or a DU (e.g., DU 127-1).

One or more RUs, such as RU 125-1, may communicate with the DU 127-1. As an example, at a cell site, three RUs may be present, each being connected with the same DU. Different RUs may be present for different portions of the spectrum. For example, a first RU may operate on the spectrum in the citizens broadcast radio service (CBRS) band while a second RU may operate on a separate portion of the spectrum, such as, for example, band 71. One or more DUs, such as the DU 127-1, may communicate with the CU 129. Collectively, an RU, DU, and CU create a gNodeB, which serves as the radio access network (RAN) of the cellular network 120. The CU 129 can communicate with the 5G core 139. The specific architecture of cellular network 120 can vary by embodiment. Edge cloud server systems outside of the cellular network 120 may communicate, either directly, via the Internet, or via some other network, with components of the cellular network 120. For example, the DU 127-1 may be able to communicate with an edge cloud server system without routing data through the CU 129 or the 5G core 139. Other DUs may or may not have this capability.

While FIG. 1 illustrates various components of the cellular network 120, other aspects of the cellular network 120 can vary the arrangement, communication paths, and specific components of the cellular network 120. While RU 125 may include specialized radio access componentry to enable wireless communication with UE 120, other components of the cellular network 120 may be implemented using either specialized hardware, specialized firmware, and/or specialized software executed on a general-purpose server system. In an O-RAN arrangement, specialized software on general-purpose hardware may be used to perform the functions of components such as the DU 127, the CU 129, and the 5G core 139. Functionality of such components can be co-located or located at disparate physical server systems. For example, certain components of the 5G core 139 may be co-located with components of the CU 129.

In a possible virtualized O-RAN implementation, the CU 129, the 5G core 139, and/or the orchestrator 138 can be implemented virtually as software being executed by general-purpose computing equipment, such as in a data center of a cloud-computing platform. Therefore, depending on needs, the functionality of the CU and/or the 5G core may be implemented locally to each other and/or specific functions of any given component can be performed by physically separated server systems (e.g., at different server farms). For example, some functions of the CU may be located at a same server facility as where the DU is executed, while other functions are executed at a separate server system. In the illustrated embodiment of system 100, cloud-based cellular network components 128 include the CU 129, the 5G core 139, and the orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

In some aspects, Kubernetes, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by the orchestrator 138. The orchestrator 138 can represent various software processes executed by underlying computer hardware. The orchestrator 138 can monitor the cellular network 120 and determine the amount and location at which cellular network functions should be deployed to meet or attempt to meet service level agreements (SLAs) across slices of the cellular network.

The orchestrator 138 can allow for the instantiation of new cloud-based components of the cellular network 120. As an example, to instantiate a new core function, the orchestrator 138 can perform a pipeline of calling the core function code from a software repository incorporated as part of, or separate from, the cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on the cellular network 120. The cellular network 120 may be shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for the UE can be varied on different slices. A network slice can be configured to provide sufficient resources for a particular application to be properly executed and delivered (e.g., gaming services, video services, voice services, location services, sensor reporting services, and data services). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at the RU 125-1 and the DU 127-1, a second set of network slices, which may only partially overlap or may be wholly different from the first set, may be reserved at the RU 125-2 and the DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as the DU 127, the CU 129, the orchestrator 138, and the 5G core 139 may include various software components that are required to communicate with each other, handle large volumes of data traffic, and to properly respond to changes in the network. In order to ensure not only the functionality and interoperability of such components, but also the ability to respond to changing network conditions and the ability to meet or perform above vendor specifications, significant testing may need to be performed.

The 5G core 139, which can be physically distributed across data centers or located at a central national data center (NDC), can perform various core functions of the cellular network. In some aspects, the 5G core 139 may include network resource management components, policy management components, subscriber management components, and packet control components, among other examples. Individual components may communicate on a bus, thus allowing various components of the 5G core 139 to communicate with each other directly. The 5G core 139 is simplified to show some key components. Implementations can involve additional other components.

Network resource management components can include network repository function (NRF) and network slice selection function (NSSF). The NRF can allow the 5G network functions (NFs) to register and discover each other via a standards-based application programming interface (API). The NSSF can be used by access and mobility management function (AMF) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include the UDM and authentication server function. The UDM can allow for generation of authentication vectors, user identification handling, NF registration management, and retrieval of UE individual subscription data for slice selection. The AUSF may perform authentication with the UE. Packet control components can include access and mobility management function (AMF) and SMF. The AMF can receive connection- and session-related information from the UE and is responsible for handling connection and mobility management tasks. The SMF is responsible for interacting with the decoupled data plane, creating updating, and removing protocol data unit (PDU) sessions, and managing session context with the UPF. The UPF can be responsible for packet routing and forwarding, packet inspection, QoS handling, and external PDU sessions for interconnecting with a data network (DN) (e.g., the Internet) or various access networks. Access networks can include the RAN of cellular network 120.

The 5G core 139 may reside on a cloud computing platform. While from a client or user point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

In some aspects, the cellular network 120 includes a locality component 150 that improves network edge protection in the cellular network 120. The locality component 150 may be implemented, for example, in a security edge protection proxy of a home network or in a network repository function of the home network, among other examples. In some aspects, the locality component 150 may determine a location of a mobile device that is connecting to a visiting network based on the mobile device being outside of a coverage area of a home network and inside of the coverage area of the visiting network. Additionally, or alternatively, the locality component 150 may determine a location of the coverage area of the visiting network to which the mobile device is connecting. The locality component 150 may provide the location information to one or more other components of the home network to be used for prioritizing local network functions of the home network. For example, the location information provided by the locality component 150 may be used to identify a primary local network function (e.g., a default AUSF) to be used by the visiting network for authenticating the mobile device and may identify one or more secondary local network functions (e.g., one or more backup AUSFs) to be used by the visiting network for authenticating the mobile device in an event that the primary local network function is unavailable. Additional details regarding these features are described below.

In some aspects, the cellular network 120 includes a locality component 150 that enables improved network edge protection in the cellular network 120. The locality component 150 may be implemented in a security edge protection proxy of a home network, among other examples. In some aspects, the locality component 150 may receive location information for a mobile device that is subscribed to the home network but that is connecting to a visiting network based on the mobile device being outside of a coverage area of the home network and within the coverage area of the visiting network. The locality component 150 may provide the location information to one or more other network components of the home network for prioritizing local network functions of the home network to which the visiting network can connect. For example, the location information provided by the locality component 150 may be used by a network repository function of the home network to identify a primary local network function (such as a default AUSF) that can be used by the visiting network to authenticate the mobile device with reduced latency. Additional details regarding these features are described below.

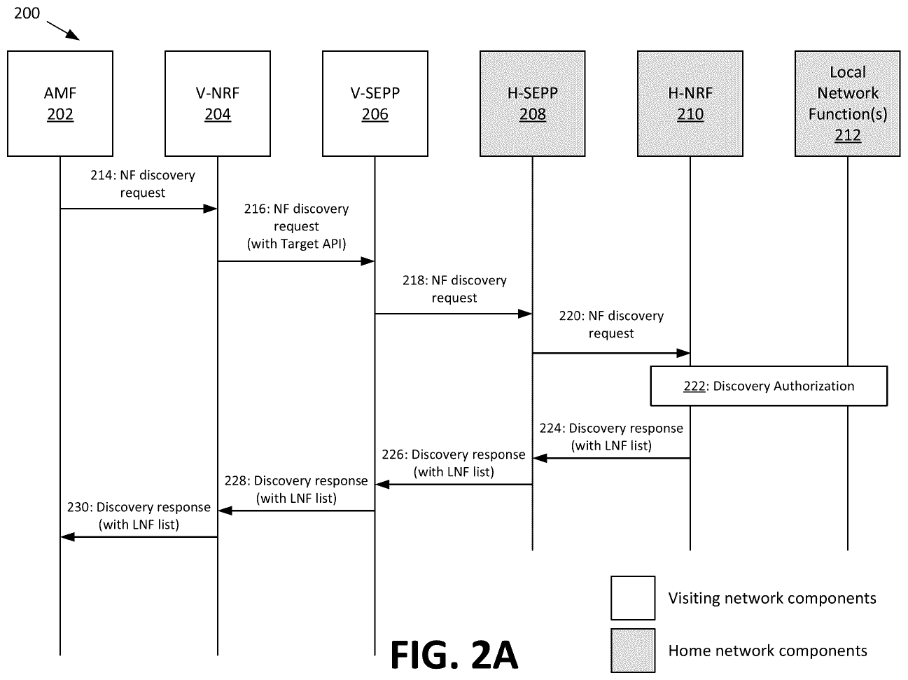

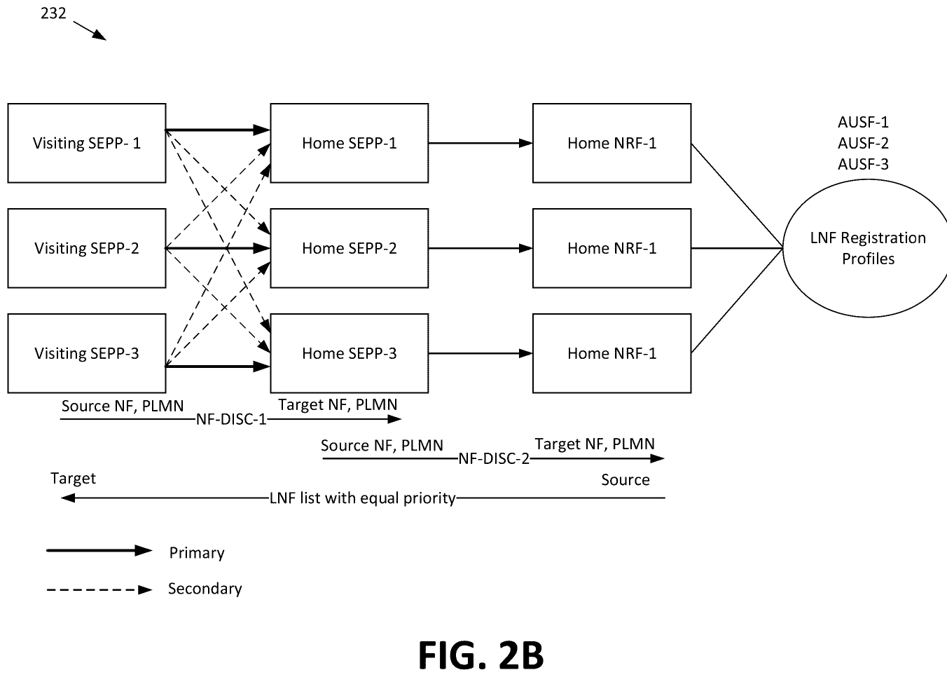

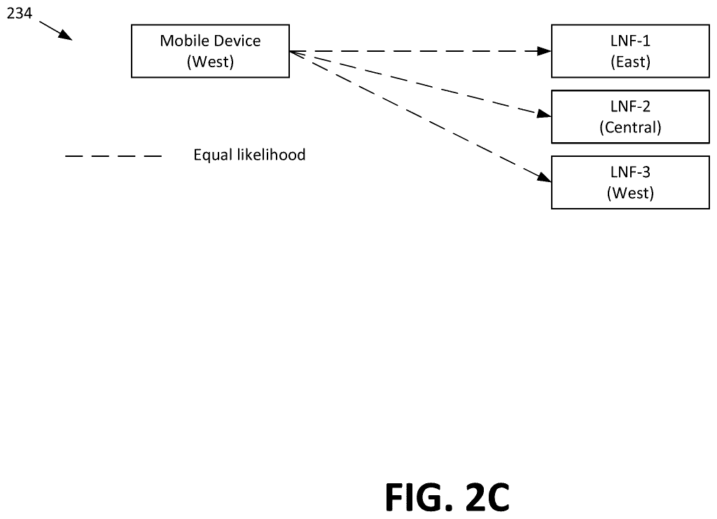

FIGS. 2A-2C are diagrams of network edge protection without using locality information, according to at least one embodiment.

As shown in FIG. 2A and example 200, one or more visiting network components and one or more home network components may be used to enable a mobile device to communicate with a wireless communication network. For example, the home network components may enable the mobile device to communicate with the wireless communication network when the mobile device is within a coverage area of the home network, whereas the visiting network components may enable the mobile device to communicate with the wireless communication network when the mobile device is outside of the coverage area of the home network and within a coverage area of the visiting network. The visiting network components may include an AMF 202, a visiting NRF (V-NRF) 204, and a visiting SEPP (V-SEPP) 206, among other examples. The home network components may include a home SEPP (H-SEPP) 208, a home NRF (H-NRF 210), and a local network function (LFN) 212, among other examples. The local network function 212 may be any local network function associated with the home network. For example, the local network function 212 may be an AUSF of the home network, a UDM of the home network, an SMF of the home network, or a UPF of the home network, among other examples.

The AMF 202 may perform access management, for example, by managing the registration and deregistration processes of the mobile device with the network. Therefore, the AMF 202 may ensure that mobile devices can connect to and disconnect from the network without errors. Additionally, the AMF 202 may perform mobility management by tracking of location of the mobile device as it moves geographically. For example, the AMF 202 may manage the states of the mobile device in terms of its activity (e.g., active, idle) and may facilitate handovers between different cells and networks to ensure continuous service as the mobile device moves. Further, the AMF 202 may participate in ensuring the security of the connections to the visiting network, including authentication of the mobile device and encryption of the signaling.

At operation 214, the AMF 202 provides a network function (NF) discovery request to the V-NRF 204. The NF discovery request may be used for discovering and locating one or more network functions (such as one or more local network functions 212).

At operation 216, the V-NRF 204 provides the NF discovery request to the V-SEPP 206. The V-SEPP 206 may function as a security gateway at an edge of the visiting network. For example, the V-SEPP 206 may use encryption and integrity protection mechanisms to ensure that data exchanged between the visiting network the home network is not intercepted or tampered with by unauthorized parties.

At operation 218, the V-SEPP 206 may send the NF discovery request to the H-SEPP 208. In some examples, the V-NRF 204 may provide the V-SEPP 206 with information that enables the V-SEPP 206 to identify the H-SEPP 208 and to connect to the H-SEPP 208. Additionally, or alternatively, the V-SEPP 206 can use domain name system (DNS) queries or other discovery mechanisms to identify the IP address or service endpoint of the H-SEPP 208. With this information, the V-SEPP 206 establishes a secure connection with the H-SEPP 208 and provides the NF discovery request to the H-SEPP 208.

At operation 220, the H-SEPP 208 provides the NF discovery request to the H-NRF 210. The H-SEPP 208 securely forwards this NF discovery request to the H-NRF 210, for example, over a standardized interface, to enable the H-NRF 210 to discover and locate one or more network functions (such as the local network function 212) on the home network.

At operation 222, the H-NRF 210 performs a discovery authorization process. The discovery authorization process may enable the H-NRF 210 to determine multiple local network functions 212 to which the visiting network can connect. Upon receiving the NF discovery request from the H-SEPP 208, the H-NRF 210 may evaluate the available local network functions against criteria specified in the request. The criteria may include parameters such as geographic location, performance capabilities, current load, and availability of the local network functions 212, among other examples. The H-NRF 210 may use a comprehensive registry of network functions, which may include details about each network function instance capability and status, to select the multiple local network functions 212 that meet the criteria of the request.

At operation 224, the H-NRF 210 provides the H-SEPP 208 with a discovery response. The discovery response may include a list of local network functions 212 to which the visiting network can connect. For example, the discovery response may include a list of local network function identified by the H-NRF 210 and may include, for each local network function 212 in the list of local network functions, a service endpoint, access credential, or context information that can be used for connecting to the local network function 212. At operation 226, the H-SEPP 208 provides the discovery response with the local network function list to the V-SEPP 206. At operation 228, the V-SEPP 206 provides the discovery response with the local network function list to the V-NRF 204. At operation 230, the V-NRF 204 provides the discovery response with the local network function list to the AMF 202.

In some examples, the H-NRF 210, to identify the multiple local network functions 212, may identify multiple UDM functions. The multiple UDM functions may include multiple UDM instances that are capable of providing subscription information associated with the mobile device to the visiting network. The H-SEPP 208 may provide a list of UDM functions to the V-SEPP 206 in a UDM list. Therefore, the LFN list may be a UDM list. However, as described herein, the visiting network (for example, the AMF 202) may not be configured with information that enables the visiting network to intelligently select which UDM function in the list of UDM functions to which the visiting network should connect. This may result in signaling latency due to the extended time period required for the visiting network to obtain the subscription information for the mobile device, for example, due to the UDM being in a location that is far from the mobile device and the coverage area of the visiting network.

As shown in FIG. 2B and example 232, a visiting SEPP (a SEPP associated with a visiting network or a secondary network) may communicate with one or more home SEPPs (SEPPs associated with a home network or a primary network). In some cases, each SEPP in the visiting network may be configured to communicate with a default SEPP (a primary SEPP) in the home network, and may be configured to communicate with another SEPP (a secondary SEPP) in the home network, for example, when the primary SEPP is not available. As shown in the example 232, visiting SEPP-1 may have a primary link with home SEPP-1, visiting SEPP-2 may have a primary link with home SEPP-2, and visiting SEPP-3 may have a primary link with home SEPP-3. Therefore, visiting SEPP-1 may communicate with home SEPP-1 by default, visiting SEPP-2 may communicate with home SEPP-2 by default, and visiting SEPP-3 may communicate with home SEPP-3 by default. Additionally, visiting SEPP-1 may have a secondary link with home SEPP-2 and home SEPP-3, visiting SEPP-2 may have a secondary link with home SEPP-1 and home SEPP-3, and visiting SEPP-3 may have a secondary link with home SEPP-1 and home SEPP-2. Therefore, visiting SEPP-1 may communicate with home SEPP-2 or home SEPP-3 if home SEPP-1 is not available, visiting SEPP-2 may communicate with home SEPP-1 or home SEPP-3 if home SEPP-2 is not available, and visiting SEPP-3 may communicate with home SEPP-1 or home SEPP-2 if home SEPP-3 is not available.

In some examples, a visiting SEPP may send a network function discovery message (NF-DISC) (shown as NF-DISC-1) to a corresponding primary home SEPP that indicates for the home SEPP to discover one or more local network functions. The network function discovery message may include an indication of the source network function (source NF) and an indication of the source public land mobile network (PLMN). For example, the network function discovery message may include an identifier of visiting SEPP-1 and a PLMN associated with visiting SEPP-1. The home SEPP may send another network function discovery message (shown as NF-DISC-2) that indicates for a home NRF to discover the one or more local network functions on the home network. The other network function discovery message may include the indication of the source network function and the source PLMN. The home NRF (such as home NRF-1) may access multiple LNF registration profiles (such as AUSF profiles, UDM profiles, SMF profiles, and/or UPF profiles) associated with the home network. Additionally, the home NRF may send, to the requesting visiting SEPP (e.g., visiting SEPP-1), an LNF list that identifies multiple LNFs that can be used by the visiting network to connect to the mobile device. The visiting SEPP may select an LNF from the list of LNFs, and may communicate with the selected LNF for authenticating the mobile device or determining subscription information for the mobile device, among other examples.

In one example, the LNF may be an AUSF. Visiting SEPP-1 may send a network function discovery request message to home SEPP-1 that includes a request for one or more AUSF identifiers. Home SEPP-1 may send another network function discover request message to NRF-1 that requests a list of AUSF registration profiles. NRF-1 may identify multiple AUSF instances, shown as AUSF-1, AUSF-2, and AUSF-3 that can be used to enable the mobile device to communicate in the visiting wireless network. NRF-1 may send, to V-SEPPI, an LNF list that indicates AUSF-1, AUSF-2, and AUSF-3. Each of AUSF-1, AUSF-2, and AUSF-3 may be assigned an equal priority. As described above, this may result in latency during the authentication process of the mobile device in the visiting wireless network.

As shown in FIG. 2C and example 234, the mobile device may connect to the visiting network (such as via the AMF 202) using LNF-1, LNF-2, or LNF-3. The mobile device may be located in a western portion of a geographic area (for example, in California). LMF-1 may be located in an eastern region of the geographic area (for example, in New York), LMF-2 may be located in a central region of the geographic area (for example, in Denver), and LMF-3 may be located in the western region of the geographic area. The mobile device may have an equal likelihood of connecting to the visiting network via LMF-1, LMF-2, and LMF-3, even though LMF-1 may introduce the most latency, LMF-2 may introduce moderate latency, and LMF-3 may introduce little latency for authenticating the mobile device or determining subscription information for the mobile device, among other examples.

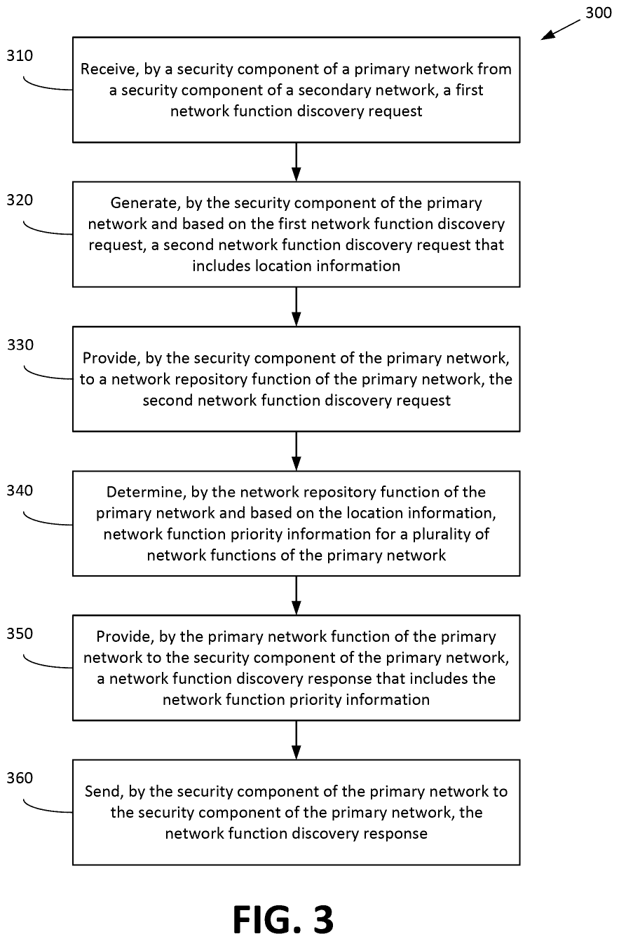

FIG. 3 is a flow diagram of an example method 300 of network edge protection using locality information, according to at least one embodiment. The method 300 may be performed by one or more home network components, one or more of which may comprise hardware (e.g., circuitry, dedicated logic, programmable logic, microcode, etc.), software (such as instructions running on the processor), firmware, or a combination thereof. In one embodiment, one or more home network components shown in FIG. 2 may perform one or more operations of the method 300.

At operation 310, a security component of a primary network (a primary network) receives, from a security component of a visiting network (a secondary network) network, a first network function discovery request. The security component of the secondary network may send the first network function discovery request to the security component of the primary network in response to a mobile device that is subscribed to the primary network being outside of a coverage area of the primary network and being within a coverage area of the secondary network. In some aspects, the security component of the primary network is a security edge protection proxy of the primary network and the security component of the secondary network is a security edge protection proxy of the secondary network.

At operation 320, the security component of the primary network generates a second network function discovery request that is based on the first network function discovery request and that includes location information. For example, the security component of the primary network may receive the first network discovery request from the security component of the secondary network and may generate a second network discovery request that includes some or all of the details in the first network discovery request and that includes the location information. In some aspects, the location information may be based on a location of the mobile device, a location of the security component of the secondary network, or a location of a network repository function of the secondary network, among other examples.

At operation 330, the security component of the primary network provides, to a network repository function of the primary network, the second network function discovery request. In some aspects, the location information is included in a header of the second network function discovery request. For example, the security component of the primary network may send, to the network repository function of the primary network, the second network function discovery request that includes the location information in a header of the second network function discovery request.

At operation 340, the network repository function of the primary network generates network function priority information for a plurality of network functions of the primary network based on the location information. The plurality of network functions of the primary network may include a plurality of authentication server functions, a plurality of unified data management functions, a plurality of session management functions, or a plurality of user plane functions, among other examples. In some aspects, the network function priority information indicates a primary network function and at least one secondary network function. In some aspects, the primary network function is a network function of the plurality of network functions of the primary network that is located closest to a current location of the mobile device. In some aspects, the network function priority information further includes priority information for two or more secondary network functions of the plurality of network functions. For example, the network function priority information may identify a primary network function, a first secondary network function, and a second secondary network function to which the visiting network is to connect (in that order).

At operation 350, the network repository function of the primary network provides, to the security component of the primary network, a network function discovery response that includes the network function priority information. For example, the network function discovery response may include a list of network functions to which the secondary network can connect. The list of network functions may be an ordered list of network functions ordered from network functions having the highest priority to network functions having the lowest priority.

At operation 360, the security component of the primary network sends, to the security component of the secondary network, the network function discovery response. In some aspects, the security component of the secondary network may send the network function discovery response to an access and mobility management function of the secondary network (e.g., via a network repository function of the secondary network and/or one or more other components of the secondary network). Further, the access and mobility management function of the secondary network may send a communication that is directed to the primary network function (or, if the primary network function is not available, a next network function in the list of network functions) in order to authenticate the mobile device or obtain subscription information for the mobile device, among other examples. As described above, this reduces latency in the wireless communications due to the primary network function of the home network being located in an area that is closer (than other network functions of the home network) to the mobile device and the coverage area of the secondary network.

In some aspects, a system may include one or more processors and one or more memories, coupled with the one or more processors and storing processor-readable instructions which, when executed by the one or more processors, cause the one or more processors to perform one or more operations of the method 300.

In some aspects, a non-transitory computer-readable storage medium may store computer-executable instructions which, when executed by one or more processors, cause the one or more processors to perform one or more operations of the method 300.

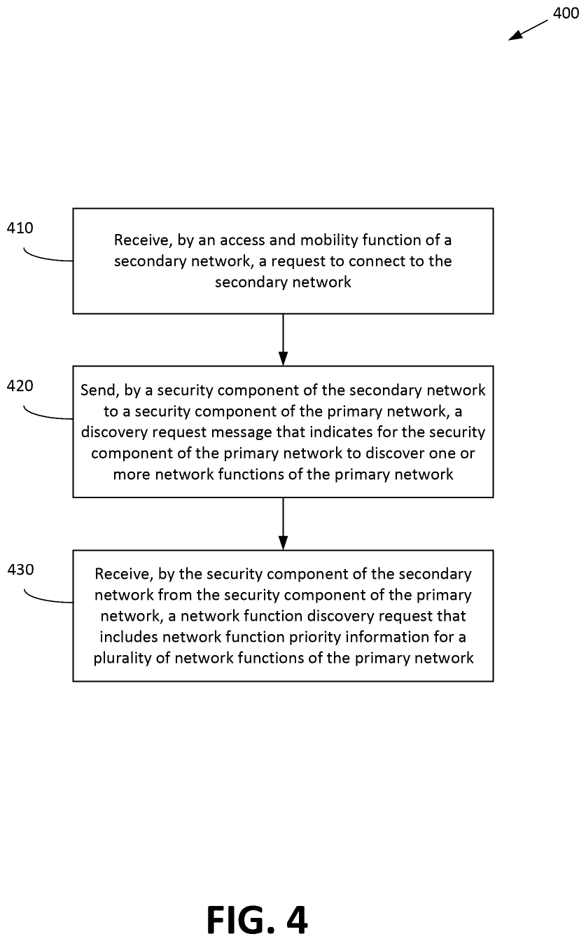

FIG. 4 is a flow diagram of an example method 400 of network edge protection using locality information, according to at least one embodiment. The method 400 may be performed by one or more visiting network components, one or more of which may comprise hardware (e.g., circuitry, dedicated logic, programmable logic, microcode, etc.), software (such as instructions running on the processor), firmware, or a combination thereof. In one embodiment, one or more visiting network components shown in FIG. 2 may perform one or more operations of the method 400.

At operation 410, an access and mobility management function of a secondary network (the visiting network) may receive a request to connect to the secondary network. The request to connect to the secondary network may be associated with a mobile device that is subscribed to a primary network (a home network) being outside of a coverage area of the primary network and within a coverage area of the secondary network. In some aspects, the security component of the primary network is a security edge protection proxy of the primary network and the security component of the secondary network is a security edge protection proxy of the secondary network.

At operation 420, the security component of the secondary network may send, to a security component of the primary network, a discovery request message that indicates for the security component of the primary network to discover one or more network functions of the primary network. The one or more network functions of the primary network may include a one or more authentication server functions of the home network, one or more unified data management functions of the home network, one or more session management functions of the home network, or one or more user plane functions of the home network, among other examples. In some aspects, the security component of the secondary network may identify the security component of the primary network based on a location of the mobile device. For example, the primary network may include multiple security components, where each security component is associated with a PLMN and a corresponding coverage area. The security component of the secondary network may obtain a list of PLMN identifiers of the home network and may select a security component of the primary network having a PLMN identifier that is closest to the mobile device.

At operation 430, the security component of the secondary network may receive, from the security component of the primary network, a network function discovery response that includes network function priority information for a plurality of network functions of the primary network. The network function priority information may be based on location information. For example, the network function priority information may be based on a location of the mobile device, a location of the security component of the secondary network, or a location of a network repository function of the secondary network, among other examples. The network function priority information indicates a primary network function of the home network and at least one secondary network function of the home network. In some aspects, the network function priority information further includes priority information for two or more secondary network functions of the plurality of network functions. For example, the network function priority information may identify a primary network function, a first secondary network function, and a second secondary network function to which the visiting network is to connect (in that order).

In some aspects, a system may include one or more processors and one or more memories, coupled with the one or more processors and storing processor-readable instructions which, when executed by the one or more processors, cause the one or more processors to perform one or more operations of the method 400.

In some aspects, a non-transitory computer-readable storage medium may store computer-executable instructions which, when executed by one or more processors, cause the one or more processors to perform one or more operations of the method 400.

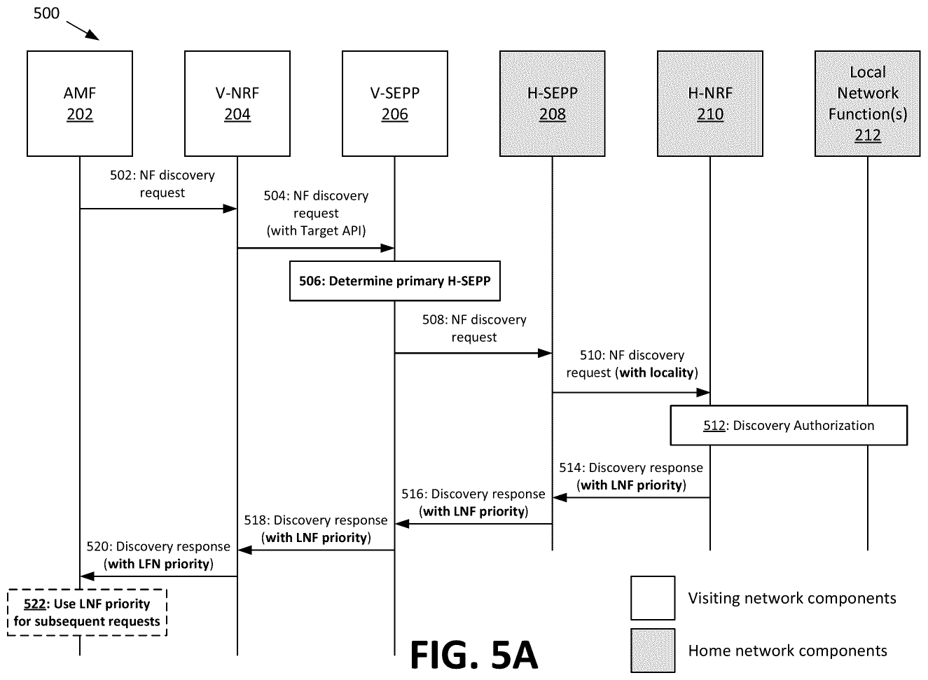

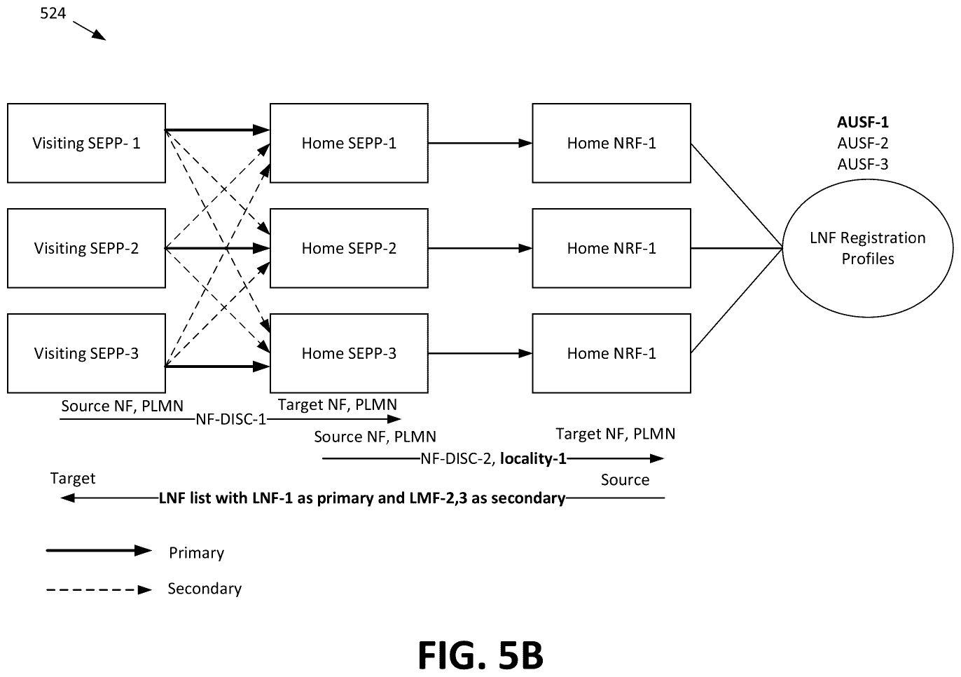

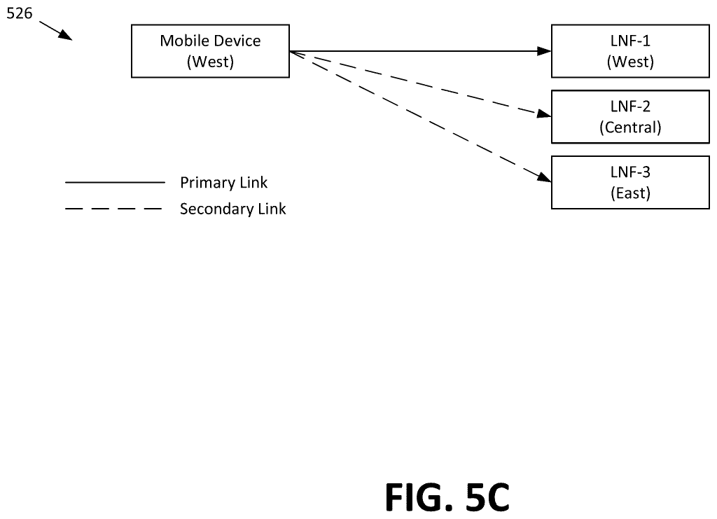

FIGS. 5A-5C are diagrams of network edge protection using locality information, according to at least one embodiment.

As shown in FIG. 5A and example 500, and as described above in connection with FIG. 2 and example 200, one or more visiting network components, such as the AMF 202, V-NRF 204, and V-SEPP 206, may communicate with one or more home network components, such as the H-SEPP 208, H-NRF 210, and one or more local network functions 212.

At operation 502, the AMF 202 provides an NF discovery request to the V-NRF 204. The NF discovery request may be used by the visiting network for discovering and locating one or more network functions (such as the one or more local network functions 212).

At operation 504, the V-NRF 204 provides the NF discovery request to the V-SEPP 206. The V-SEPP 206 may function as a security gateway at an edge of the visiting network. For example, the V-SEPP 206 may use encryption and integrity protection mechanisms to ensure that data exchanged between the visiting network the home network is not intercepted or tampered with by unauthorized parties. In some aspects, the V-NRF 204 may determine a target API. The target API may refer to the specific API that a network function intends to utilize when interacting with another network function within a service-based architecture (SBA) of the wireless communication network. The target APIs may define the methods and data formats that the network functions use to communicate, enabling standardized, efficient, and secure interactions across the network. In some aspects, the NF discovery request provided by the V-NRF 204 to the V-SEPP 206 may include an indication of the target API.

At operation 506, the V-SEPP 206 may determine the primary H-SEPP of the home network. The V-SEPP 206 may determine the primary H-SEPP 208 of the home network using information provided during an initial connection attempt between the mobile device and the visiting network. In some aspects, the home network may include multiple H-SEPPs, where each H-SEPP is associated with a PLMN and a corresponding coverage area. The V-SEPP 206 may obtain (e.g., from the V-NRH 204) a list of PLMN identifiers of the home network, and may select an H-SEPP of the primary network having a PLMN identifier that is located closest to the mobile device.

At operation 508, the V-SEPP 206 may send the NF discovery request to the H-SEPP 208. The NF discovery request may be provided by the V-SEPP 206 to the H-SEPP 208 in order to enable the H-SEPP 208 to discover or locate network functions (such as the local network functions 212) that can be used for authenticating (among other examples) the mobile device.

At operation 510, the H-SEPP 208 provides the NF discovery request to the H-NRF 210. The H-SEPP 208 securely forwards this NF discovery request to the H-NRF 210, for example, over a standardized interface, to enable the H-NRF 210 to discover and locate one or more network functions (such as the local network function 212) on the home network. As described herein, the NF discovery request provided by the H-SEPP 208 to the H-NRF 210 may include locality information. The locality information may indicate a location of the mobile device, a location of the V-SEPP 206, or a location of the V-NRF 204, among other examples.

At operation 512, the H-NRF 210 performs a discovery authorization process. The discovery authorization process may enable the H-NRF 210 to determine multiple local network functions 212 to which the visiting network can connect. Upon receiving the NF discovery request from the H-SEPP 208, the H-NRF 210 may evaluate the available local network functions against criteria specified in the request. The criteria may include parameters such as geographic location, performance capabilities, current load, and availability of the local network functions 212, among other examples. The H-NRF 210 may use a comprehensive registry of network functions, which may include details about each network function instance capability and status, to select the multiple local network functions 212 that meet the criteria of the request. In some aspects, the discovery authorization process may be performed using the locality information. For example, the H-NRF 210 may use the locality information to identify local network functions 212 that are nearby the mobile device, the V-SEPP 206, or V-NRF 204, among other examples.

At operation 514, the H-NRF 210 provides the H-SEPP 208 with a discovery response. The discovery response may be based on the discovery authorization process and may include a list of multiple local network functions 212 to which the visiting network can connect. The discovery response may include local network function (LNF) priority information for the multiple local network functions 212. The LFN priority information may indicate a priority for each local network function 212 of the multiple the local network functions 212. The priority for the local network functions 212 may be based on the locality information. For example, the priority information may indicate a primary network function corresponding to a local network function 212 that is located closest to the mobile device, and may indicate one or more secondary network functions 212 that are located further from the mobile device than the primary network function is to the mobile device. In some aspects, the priority information may include a list of local network functions 212 ordered from the primary network function 212 (for example, closest to the mobile device) to least desirable network function 212 (for example, furthest from the mobile device).

At operation 516, the H-SEPP 208 provides the discovery response with the local network function list and the local network function priority information to the V-SEPP 206. At operation 518, the V-SEPP 206 provides the discovery response with the local network function list and the local network function priority information to the V-NRF 204. At operation 520, the V-NRF 204 provides the discovery response with the local network function list and the local network function priority information to the AMF 202.

At operation 522, the AMF 202 may use the LNF priority information for subsequent requests to the home network. In one example, the AMF 202 may communicate with the primary network function 212 (for example, a primary AUSF) for authenticating the mobile device. In another example, the AMF 202 may communicate with the primary network function 212 (for example, a primary UDM) for obtaining subscription information for the mobile device. In another example, the AMF 202 may communicate with the primary network function 212 for transmitting data to, and receiving data from, the mobile device. As set forth in the flow of FIG. 5B, a visiting UPF can communicate with the home UPF. As described herein, this may reduce latency (such as signaling latency) in the wireless network.

As shown in FIG. 5B and example 524, a visiting SEPP (a SEPP associated with a visiting network or a secondary network) may communicate with one or more home SEPPs (SEPPs associated with a home network or a primary network). In some cases, each SEPP in the visiting network may be configured to communicate with a default SEPP (a primary SEPP) in the home network, and may be configured to communicate with another SEPP (a secondary SEPP) in the home network, for example, when the primary SEPP is not available. As shown in the example 524, visiting SEPP-1 may have a primary link with home SEPP-1, visiting SEPP-2 may have a primary link with home SEPP-2, and visiting SEPP-3 may have a primary link with home SEPP-3. Therefore, visiting SEPP-1 may communicate with home SEPP-1 by default, visiting SEPP-2 may communicate with home SEPP-2 by default, and visiting SEPP-3 may communicate with home SEPP-3 by default. Additionally, visiting SEPP-1 may have a secondary link with home SEPP-2 and home SEPP-3, visiting SEPP-2 may have a secondary link with home SEPP-1 and home SEPP-3, and visiting SEPP-3 may have a secondary link with home SEPP-1 and home SEPP-2. Therefore, visiting SEPP-1 may communicate with home SEPP-2 or home SEPP-3 if home SEPP-1 is not available, visiting SEPP-2 may communicate with home SEPP-1 or home SEPP-3 if home SEPP-2 is not available, and visiting SEPP-3 may communicate with home SEPP-1 or home SEPP-2 if home SEPP-3 is not available.

In some examples, a visiting SEPP (such as visiting SEPP-1) may send a network function discovery message (shown as NF-DISC-1) to a corresponding primary home SEPP (such as home SEPP-1) that indicates for the home SEPP to discover one or more local network functions on the home network. The network function discovery message may include an indication of the source network function (source NF) and an indication of the source PLMN. For example, the network function discovery message may include an identifier of the visiting SEPP-1 and a PLMN associated with visiting SEPP-1. The home SEPP may send another network function discovery message (shown as NF-DISC-2) that indicates for a home NRF (such as home NRF-1) to discover the one or more local network functions on the home network. The other network function discovery message may include the indication of the source network function and the source PLMN. Additionally, the other network function discovery message may include locality information (as described herein). For example, NF-DISC-2 may indicate “locality-1” which indicates that the mobile device is located at a location that corresponds to locality-1 (e.g., a western portion of the geographic area). The home NRF may access multiple LNF registration profiles (such as AUSF profiles, UDM profiles, SMF profiles, and/or UPF profiles) associated with the home network. Additionally, the home NRF may send, to the visiting SEPP, LNF priority information that indicates priorities for multiple LNFs that can be used by the visiting network to connect to the mobile device. For example, as described above, the LNF priority information may indicate a primary LNF (NLF-1) corresponding to locality-1, and may indicate one or more secondary LNFs (LNF-2 and LNF-3) that can be used as secondary LNFs. The visiting SEPP may select LNF-1 (such as AUSF-1) and may communicate with the selected LFN for authenticating the mobile device or determining subscription information for the mobile device, among other examples, thereby reducing signaling latency.

As shown in FIG. 2C and example 526, the mobile device may connect to the visiting network (such as via the AMF 202) using LNF-1, LNF-2, or LNF-3. The mobile device may be located in a western portion of a geographic area (for example, in California). LMF-1 may be located in an eastern region of the geographic area (for example, in New York), LMF-2 may be located in a central region of the geographic area (for example, in Denver), and LMF-3 may be located in the western region of the geographic area. In this example, based on the priority information, the visiting network may connect to the mobile device using LNF-1. If LNF-1 is not available, the visiting network may connect to the mobile device using either LNF-2 or LNF-3.

In the above description, numerous details are set forth. It will be apparent, however, to one of ordinary skill in the art having the benefit of this disclosure, that aspects may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMS, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method comprising:
receiving, by a security component of a primary network from a security component of a secondary network, a first network function discovery request, wherein the first network function discovery request is associated with a mobile device that is subscribed to the primary network being outside of a coverage area of the primary network and within a coverage area of the secondary network;
generating, by the security component of the primary network and based on the first network function discovery request, a second network function discovery request that includes location information;
providing, by the security component of the primary network to a network repository function of the primary network, the second network function discovery request;
determining, by the network repository function of the primary network and based on the location information, network function priority information for a plurality of network functions of the primary network;
providing, by the network repository function of the primary network to the security component of the primary network, a network function discovery response that includes the network function priority information; and
sending, by the security component of the primary network to the security component of the secondary network, the network function discovery response.

2. The method of claim 1, wherein the location information is based on a location of the mobile device, a location of the security component of the secondary network, or a location of a network repository function of the secondary network.

3. The method of claim 1, wherein the plurality of network functions of the primary network includes a plurality of authentication server functions, a plurality of unified data management functions, a plurality of session management functions, or a plurality of user plane functions.

4. The method of claim 1, wherein the network function priority information indicates a primary network function and at least one secondary network function.

5. The method of claim 4, wherein the primary network function is a network function of the plurality of network functions that is located closest to the mobile device.

6. The method of claim 4, further comprising receiving, from an access and mobility management function of the secondary network, a communication that is directed to the primary network function.

7. The method of claim 4, wherein the network function priority information further includes priority information for two or more secondary network functions of the plurality of network functions.

8. The method of claim 1, wherein the location information is included in a header of the second network function discovery request.

9. The method of claim 1, wherein the security component of the primary network is a security edge protection proxy of the primary network and the security component of the secondary network is a security edge protection proxy of the secondary network.

10. A method comprising:
receiving, by an access and mobility management function of a secondary network, a request to connect to the secondary network, wherein the request to connect to the secondary network is associated with a mobile device that is subscribed to a primary network being outside of a coverage area of the primary network and within a coverage area of the secondary network;
sending, by a security component of the secondary network to a security component of the primary network, a discovery request message that indicates for the security component of the primary network to discover one or more network functions of the primary network; and
receiving, by the security component of the secondary network from the security component of the primary network, a network function discovery response that includes network function priority information for a plurality of network functions of the primary network, wherein the network function priority information is based on location information that is based on a location of the mobile device, a location of the security component of the secondary network, or a location of a network repository function of the secondary network.

11. The method of claim 10, further comprising identifying, by the security component of the secondary network and based on the location of the mobile device, the security component of the primary network.

12. The method of claim 10, wherein the plurality of network functions of the primary network includes a plurality of authentication server functions, a plurality of unified data management functions, a plurality of session management functions, or a plurality of user plane functions.

13. The method of claim 10, wherein the network function priority information indicates a primary network function and at least one secondary network function.

14. The method of claim 13, wherein the primary network function is a network function of the plurality of network functions that is located closest to the mobile device.

15. The method of claim 13, further comprising sending, by the access and mobility management function of the secondary network, a communication that is directed to the primary network function.

16. The method of claim 10, wherein the security component of the primary network is a security edge protection proxy of the primary network and the security component of the secondary network is a security edge protection proxy of the secondary network.

17. A system comprising:
one or more processors; and
one or more memories, coupled with the one or more processors, storing processor-readable instructions which, when executed by the one or more processors, cause the one or more processors to perform operations comprising:
receiving, by a security component of a primary network from a security component of a secondary network, a first network function discovery request, wherein the first network function discovery request is associated with a mobile device that is subscribed to the primary network being outside of a coverage area of the primary network and within a coverage area of the secondary network;
generating, by the security component of the primary network and based on the first network function discovery request, a second network function discovery request that includes location information;
providing, by the security component of the primary network to a network repository function of the primary network, the second network function discovery request;
determining, by the network repository function of the primary network and based on the location information, network function priority information for a plurality of network functions of the primary network;
providing, by the network repository function of the primary network to the security component of the primary network, a network function discovery response that includes the network function priority information; and
sending, by the security component of the primary network to the security component of the secondary network, the network function discovery response.

18. The system of claim 17, wherein the location information is based on a location of the mobile device, a location of the security component of the secondary network, or a location of a network repository function of the secondary network.

19. The system of claim 17, wherein the plurality of network functions of the primary network includes a plurality of authentication server functions, a plurality of unified data management functions, a plurality of session management functions, or a plurality of user plane functions.

20. The system of claim 17, wherein the network function priority information indicates a primary network function and at least one secondary network function.
